(19) United States
(12) Patent Application Publication
(10) Pub. No.: US 2004/0022928 A1
(43) Pub. Date: Feb. 5, 2004

(54) Feed supplement composition for ruminants and a process to obtain the same

(76) Inventor: Gary Derks, Chesterville (CA)

Correspondence Address: Baker McLachlen, Station D, P.O. Box 2780, Ottawa, ON, K1P 5W8, CA

(21) Appl. No.: 10/211,312

(22) Filed: Aug. 5, 2002

(51) Int. Cl. A23L 1/20

(52) U.S. Cl. 426/630

(57) ABSTRACT

A process to obtain a feed supplement composition for ruminants comprises the steps: a) cleaning whole raw grains, b) heat treating the whole grains, c) transporting the heat treated whole grains to a vented steeping tank through a flow control system, d) spraying a nitrogenous compound, from a compound tank with a flow control system, into the steeping tank, over the heat treated whole grains, e) crushing the heat treated grains combined with the nitrogenous compound, f) cooling the heat treated and crushed grains in a cooling drum, g) optionally further spraying the nitrogenous compound into the cooling drum, over the heat treated and crushed grains, and h) recovering the feed composition. A feed supplement composition for ruminants, obtained through the above described process, containing: a) at least one variety of raw grains, combined with b) a 5 to 40% nitrogenous compound.

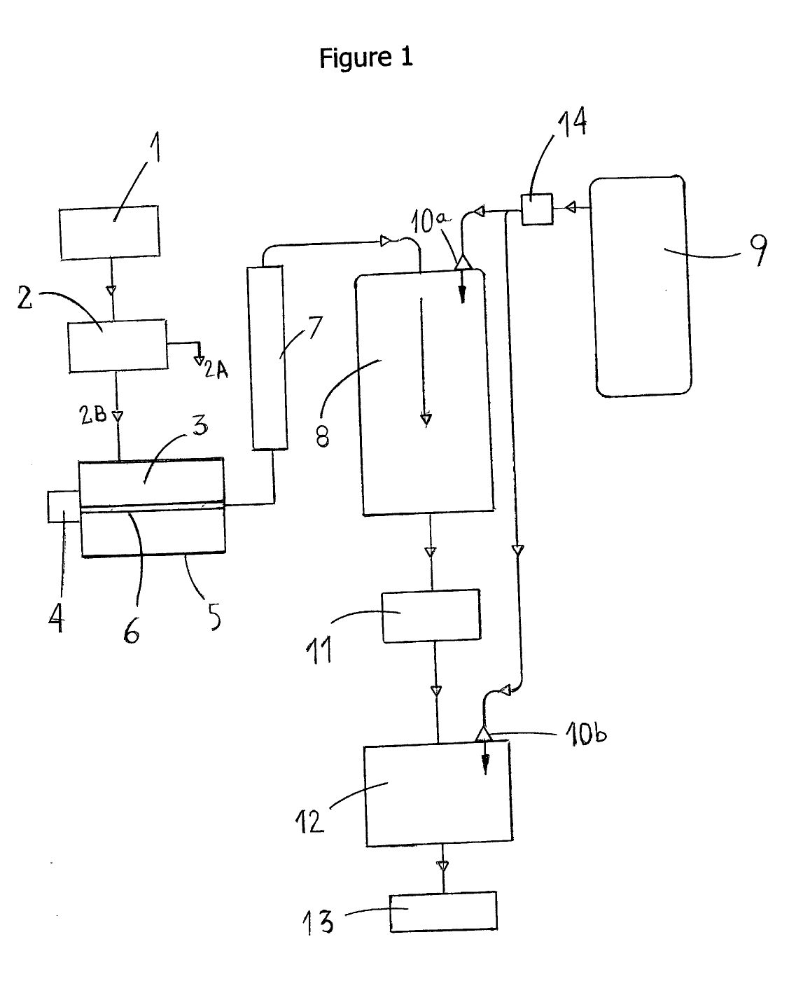

### FIELD OF THE INVENTION

The present invention relates to a process to obtain a feed supplement for ruminants, and a feed supplement composition combining heat treated grains and a nitrogenous compound.

### BACKGROUND OF THE INVENTION

Animal nutrition is based on four main types of food: a) voluminous food, b) concentrates, c) additives and d) supplements. Grains and grain meals are largely used in feed supplements, specially as energy and protein sources. Among the large variety of grains that are used, soybeans are excellent sources of protein and energy, when incorporated into supplements, feeds and rations.

Known for its high protein content and for its utilization in different kinds of nutrition processes and foods, the use of soybeans in animal nutrition is increasing; however, raw grains cannot be used for ruminant consumption and for monogastric animal nutrition, as the grains have certain compounds called antinutrients, such as the anti-Trypsin factor, an enzyme inhibitor which blocks the action of trypsin, which is an enzyme required for protein digestion; urease (urea degradator); hemaglutinin, an agglutination activating substance that promotes red blood cell agglutination; and phytates, that impede the uptake of essential minerals during digestion.

B. Harris Jr, in “Feeding Raw or Heat-treated Whole Grains to Dairy Cattle”—IFAS/University of Florida, DS28 of March 1990, says that “ruminants animals such as cattle, sheep and goats can utilize grains without being processed. Even so, warnings frequently occur on feed tags, even for dairy animals. The reason for this warning usually involves the use of urea or similar compounds. The urease in raw grains when in contact with urea, destroys the efficient use of urea and releases ammonia, thus, urea should not be added to rations containing ground raw grains”.

These antinutrients are eliminated or at least reduced under thermal treatment, which makes a heat treatment imperative for any kind of ruminant or monogastric animal nutrition, where there is soybean consumption. As described by Belitz and Grosch in Food Chemistry-2nd Edition 1987, highly thermostable inhibitors are present in soybean, such as the Bowman-Birck inhibitor (trypsin inhibitor), and chymotrypsin. There is another proteinase inhibitor, isolated by Kunitz, which is less thermostable. Thus, a correct and proper heat treatment is necessary to ensure safe consumption and to have the best benefit from grain proteins. Different processes of heat treatments are known in the art, such as: roasting, extrusion, micronization, microwaving, boiling and jet explosion.

Teissier, in U.S. Pat. No. 3,937,846, describes a process which involves preparing animal feed compositions comprised of a dry mixture containing 35 to 48 parts of urea with 52 to 65 parts of urea phosphate, melting the urea-urea phosphate mixture at a temperature of 72° C. to 90° C., absorbing the molten mixture in an animal feed material, and cooling the feed material containing the mixture. Teissier also adds a number of other materials to the mixture including at least one basic material, at least one sulfate, nutritional trace elements, vitamins, and molasses. The feed material is also identified as Chinese palm kernel cake. Although the Teissier invention concerns production of animal feed, Teissier's process employs large amounts, or concentrations of urea; the urea-urea phosphate used therein is mixed then melted at temperatures not exceeding 90 degrees Celsius.

Deyoe, in U.S. Pat. No. 4,232,046 discloses a process whereby a substantially non-protein nitrogen (NPN)-free aqueous slurry is formed comprising water and a solids fraction which includes a quantity of an edible, substantially ungelatinized, starch-bearing feed material. The slurry is then directed through a reaction zone and treated at elevated pressures and high temperatures to gelatinize at least a portion of the starch-bearing feed material. Subsequent to this treatment, the slurry can be fortified by addition of an NPN source such as urea to yield a final feed product. The starch-bearing feed material is selected from a group consisting of corn, sorghum, barley, oats, wheat, rice, millet, potatoes, yams, cassaya, arrowroot, turnips, rutabagas, corn starch, potato starch, wheat starch, starch-bearing food and beverage processing waste liquors, and mixtures thereof. The Deyoe process need not employ urea as a source of NPN but can use any of a group of NPN bearing substances such as: urea, uric acid, biuret, ethylene urea, ammonia, ammonium salts, propionamide, butyramide, formamide, acetamide, dicyanodiamide, isobutane diurea, creatinine, creatine, lactosyl urea, urea phosphate, fermented ammoniated condensed whey, and mixtures thereof. Also, the starch-bearing feed material that Deyoe uses does not include grains.

Stahel, in U.S. Pat. No. 4,450,176, discloses a process in which soybean material is placed in a closed vessel to which alcohol is added. Agitators in the vessel fluidize the soybean material, and steam is then injected into the vessel and through the soybean material, heating the material. The fluidization of the protein in the presence of heat alters the protein structure for better digestibility and undesirable flavours are removed by the alcohol. Stahel employs only heat in the denaturing process rather than a combination of heat and chemicals, such as urea. Additionally, alcohol is used to remove offensive flavours from the feed material.

Potts, in CA 1078663, describes a process consisting of introducing dry feed basal, soapstock and an aqueous solution of 50 to 90% urea into a conditioner, mixing these constituents, conditioning them and then pelletizing the mixture. The order of the mixture is important, as the soapstock must be present in the basal prior to addition of the urea to prevent premature crystallization of the urea. Although the feed basal includes 1.6% dehulled soybean meal, it is also comprised of dehydrated alfalfa, calcium carbonate, gypsum, dicalcium phosphate, sodium chloride, and animal fat.

“Soybean Feeding on the Farm” published by the ‘Ontario Soybean Growers Marketing Board’ as supplement 1993/94 contains considerable information relating to the heat treating and processing of soybeans for animal consumption, and the teachings thereof are incorporated herein by reference.

### SUMMARY OF THE INVENTION

The invention seeks to provide a combination of heat treated grains and a nitrogenous compound, using a simpler process than the previously discussed patents.

As a definition for this invention, grains include any kind of grains and oilseeds.

The invention seeks to provide a process for preparing a feed supplement composition for ruminants, comprising the following steps:

(a) heat treating the raw grains at temperatures ranging from 180° F. to 350° F., for 30-120 seconds;

(b) transporting the heat treated grains to a vented steeping tank, through a flow control system;

(c) spraying a nitrogenous compound from a compound tank with a flow control system, over the heat treated grains using a dosage ranging from 10 kg to 100 kg of nitrogenous compound/tonne of grains;

(d) steeping the heat treated grains, with an infeed temperature ranging from 100-310° F. and an outfeed temperature of ranging from 90-280° F., for an average residence time of about 35 minutes;

(e) crushing the heat treated grains infused with the nitrogenous compound;

(f) cooling the heat treated and crushed grains infused with the nitrogenous compound in a cooling drum, to an outfeed temperature ranging from 180° F. to 190° F.;

(g) optionally spraying the nitrogenous compound, from the compound tank, using a flow control system, into the cooling drum, over the heat treated and crushed grains, using a dosage ranging from 10 kg to 100 kg of nitrogenous compound/tonne of grains; and

(h) recovering the feed supplement composition.

Preferably, the raw grains are soybeans, and the heat treatment is carried out by flame roasting, dry roasting, extrusion, micronization, microwaving, boiling, jet explosion or a combination of at least two of these processes. The steeping process allows the urea to infuse into the heated grains.

The invention, further seeks to provide a feed supplement composition for ruminants, containing:

(I) at least one variety of heat treated grains; combined with

(II) a 5 to 40% nitrogenous compound.

As described, the invention involves a process of heating grains. The grains are then mixed with 5-40% nitrogenous compound. Different nitrogenous commercial products, from various manufacturers, can be used to obtain the desired percentage of nitrogen. Examples of these compounds are an urea-ammonia nitrate aqueous solution containing 28% nitrogen, an urea-ammonia nitrate aqueous solution containing 32% nitrogen, an aqua ammonia aqueous solution containing 20% nitrogen, anhydrous ammonia containing 82% nitrogen and a combination of at least two of these compounds.

The present invention uses heat to treat raw grains, preferably raw soybeans such that the urease enzyme is inactivated. This increases the shelf life of the beans by destroying the lipase enzyme, and increases the soybean bypass protein content, reaching up to 39.04% of bypass in the rumen. Bypass protein is that substance which does not undergo rumen fermentation and is available for absorption in the small intestine thus ultimately providing a larger amount of protein to meet the animal's requirements. A nitrogenous compound, preferably urea and/or ammonia is added to the soybean material to provide a dietary supplement having nitrogen for additional protein production.

With the exception of grains themselves, none of the previously listed feed materials of the prior art, are utilized in the present invention. Also, in the Potts patent the order of mixing of the feed constituents is different from the present invention. The urea concentrations used by Potts are different, and this invention does not require the use of soapstock.

In the case of using extrusion as the heat treatment process, the steeping process is not needed and the nitrogenous compound will be combined with the grains before or during the extrusion process using a dosage ranging from 10 kg to 100 kg of nitrogenous compound/tonne of grains.

The soybean based feed supplement of the present invention fits well with a high corn silage ration to provide a complete high protein cattle feed.

### DESCRIPTION OF THE DRAWING

Referring to the drawing, a preferred apparatus for preparing a feed supplement composition for ruminants is shown.

In this preferred apparatus, stored raw soybeans (1), are fed into a cleaner (2) for screening. The debris is separated leaving in line (2A), and the cleaned beans leaving in line (2B) are then transported to a flame rotary roaster (3) for heat treatment. The roaster includes a burner (4), a rotary drum (5) and a flame (6), projected from the burner (4). Afterwards, the heat treated grains are transported through a flow control system shown as an elevator leg (7), to a vented mass flow steeping tank (8) where a nitrogenous solution, from a solution tank (9) with a flow control system (14), is sprayed onto the heat treated beans, using a sprayer (10a) as they enter the tank (8). Typically the beans have a temperature of 290° F. at the top of the tank and an outfeed temperature of 230° F., and an average residence time of about 35 minutes. Typically, 55 kg of solution is used per tonne of grains. The heat treated grains infused with the nitrogenous solution are then moved through a crusher (11), and then moved to a cooling drum (12) where a cooling process with an outfeed temperature of 180° F. takes place and where the nitrogenous solution from the solution tank (9) with the flow control system (14), is optionally sprayed once again, using a sprayer (10b) over the heat treated and crushed grains. The feed composition is recovered in the final station (13). In the crusher (11) the heat treated grains are at least partially broken up, so that they are at least fractured, a proportion of them are broken down into flakes.

### DESCRIPTION OF THE PREFERRED EMBODIMENTS

A preferred embodiment for the process for preparing a feed supplement composition for ruminants of the present invention, comprises the following steps:

(a) feeding whole soybeans into a cleaner (2) for screening, and recovering cleaned soybeans;

(b) roasting whole soybeans from step (a) to a temperature of about 180° F. to 350° F., for 30 to 120 seconds, in a flame rotary roaster (5) comprising:

(i) a burner (4);

(ii) a rotary drum (5); and

(iii) a flame (6) inside the drum.

(c) transporting the heat treated whole soybeans to a vented mass flow steeping tank (8), through a leg (7);

(d) steeping in the steeping tank (8) the heat treated soybeans and spraying the roasted beans with 55 kg/tonne of beans of a urea-based aqueous nitrogen solution, containing 28% nitrogen consisting of: 31% urea, 39% ammonium nitrate, and 30% water, from a solution tank with a flow control system, with an infeed temperature of about 290° F. and an outfeed temperature of about 230° F., for an average residence time of about 35 minutes;

(e) crushing the heat treated beans infused with the aqueous nitrogen solution, in a crusher;

(f) cooling the heat treated and crushed beans infused with the aqueous nitrogen solution in a cooling drum, to an outfeed temperature of about 180° F.; and

(g) optionally spraying the 28% urea-based nitrogenous solution, from the solution tank (9), using the flow control system (14), into the cooling drum, over the heat treated and crushed beans, using a dosage of 55 kg of nitrogen solution/tonne of beans; and

(h) recovering the feed supplement composition.

Laboratory analysis presented very good results for the feed composition. Results obtained on the feed supplement on an “as is” basis, are presented below:

| Content | Sample 1 | Sample 2 |
|---|---|---|
| Moisture % | 6.84 | 4.75 |
| Protein % (N × 6.25) | 45.74 | 44.92 |
| Calcium % | 0.22 | 0.19 |
| Phosphorus % | 0.58 | 0.59 |
| Sodium % | 0.02 | 0.02 |
| Potassium % | 1.83 | 1.93 |
| Magnesium % | 0.25 | 0.24 |
| Zinc (ppm) | 45.92 | 40.46 |
| Manganese (ppm) | 19.08 | 17.98 |
| Copper (ppm) | 14.14 | 11.95 |
| Acid Detergent Fibre % | 15.00 | 10.10 |
| Undegraded Intake Protein % | 49.41 | 50.91 |
| of Crude Protein (bypass) | | |
| Degraded Intake Protein % | 50.59 | 49.09 |
| of Crude Protein | | |

In the above description a continuous flow process is described. This process can also be carried out as a batchwise operation. Those skilled in the art of roasting soybeans will realize that the beans will only need cleaning if they are as harvested by the combine. It is not essential that the beans be cleaned as a preliminary to the roasting step, if such cleaning was done prior to storage of the raw beans.

1. A process for preparing a feed supplement composition for ruminants, comprising the following steps:
(a) heat treating cleaned grains at temperatures ranging from 180° F. to 350° F., for 30 to 120 seconds;
(b) combining the heat treated grains with a nitrogen compound, from a compound tank with a flow control system, using a dosage ranging from 10 kg to 100 kg of nitrogen compound/tonne of grains;
(c) cooling the heat treated grains combined with the nitrogenous compound in a cooling drum, to an outfeed temperature ranging from 180° F. to 190° F., the infeed temperature being higher than the outfeed temperature;
(d) spraying the nitrogenous compound, from the compound tank with the flow control system, into the cooling drum, over the heat treated grains, using a dosage ranging from 10 kg to 100 kg of nitrogenous compound/tonne of grains; and
(e) recovering the feed composition.

2. A process for preparing the feed supplement composition for ruminants according to claim 1, wherein the grains are soybeans.

3. A process for preparing the feed supplement composition for ruminants, according to claim 1, further comprising a cleaning, added to the process before the heat treatment, recovering cleaned raw grains.

4. A process for preparing the feed supplement composition for ruminants, according to claim 1, further comprising a crushing, added to the process between the steeping tank and the cooling drum, in which the heat treated grains combined with the nitrogenous compound are at least broken up.

5. A process for preparing the feed supplement composition for ruminants, according to claim 1, wherein the heat treatment process is selected from the group consisting of flame roasting, dry roasting, extrusion, micronization, microwaving, boiling, jet explosion and a combination of at least two of these processes.

6. A process for preparing the feed supplement composition for ruminants, according to claim 5, wherein the heat treatment process is extrusion.

7. A process for preparing the feed supplement composition for ruminants, according to claim 5, wherein the heat treatment process is flame roasting.

8. A process for preparing the feed supplement composition for ruminants, according to claim 7, further comprising transporting the heat treated grains to a vented steeping tank, through a flow control system after the heat treatment.

9. A process for preparing the feed supplement composition for ruminants, according to claim 8, further comprising steeping the heat treated grains by spraying a nitrogen compound, from a compound tank with a flow control system, into the steeping tank, over the heat treated grains, using a dosage ranging from 10 kg to 100 kg of nitrogen compound/tonne of grains, with an infeed temperature ranging from 100-310° F. and an outfeed temperature ranging from 90-280° F., the infeed temperature being higher than the outfeed temperature, for an average residence time of about 35 minutes.

10. A process for preparing the feed supplement composition for ruminants, according to claim 9, wherein the steeping process is a mass flow steeping process.

11. A feed supplement composition for ruminants, obtained from the above claimed process, containing:
(i) at least one variety of heat treated grains; combined with
(ii) a 5 to 40% nitrogenous compound.

12. A feed supplement composition for ruminants, according to claim 11, wherein the grains are grains of equal protein and oil content.

13. A feed supplement composition for ruminants, according to claim 11, wherein the grains are grains of different protein and oil content.

14. A feed supplement composition for ruminants, according to claim 11, wherein the nitrogenous compound is selected from the group consisting of urea, ammonia and a combination of urea and ammonia.

15. A feed supplement composition for ruminants, according to claim 14, wherein the nitrogenous compound is selected from the group consisting of urea-ammonia nitrate, aqua ammonia, anhydrous ammonia and a combination of at least two of these compounds.

16. A feed supplement composition for ruminants, according to claim 15, wherein the nitrogenous compound is selected from the group consisting of 28% nitrogen urea-ammonia nitrate aqueous solution, 32% nitrogen urea-ammonia nitrate aqueous solution, 20% nitrogen aqua ammonia aqueous solution, 82% nitrogen ammonia and a combination of at least two of these compounds.

17. A soybean based feed supplement for ruminants comprising roasted soybeans infused with a nitrogenous solution during roasting and steeping of the beans.

18. A feed supplement as defined in claim 11, combined with corn silage, to provide a complete high protein cattle feed.
